(19) United States
(12) Patent Application Publication
(10) Pub. No.: US 2016/0236130 A1
(43) Pub. Date: Aug. 18, 2016

(54) POSITIVE PRESSURE AIRFLOW BLOWER POWERED FILTRATION DEVICE

(71) Applicants: William J. HASLEBACHER, Bellevue, WA (US); Frank FERRIS, Bellevue, WA (US); William G. BLUM, Issaquah, WA (US)

(72) Inventors: William J. Haslebacher, Bellevue, WA (US); Frank Ferris, Bellevue, WA (US); William G. Blum, Issaquah, WA (US)

(21) Appl. No.: 15/031,562

(22) PCT Filed: Oct. 27, 2014
(86) PCT No.: PCT/US2014/062450

§ 371 Date: Apr. 22, 2016

Related U.S. Application Data
(60) Provisional application No. 61/895,627, filed on Oct. 25, 2013.

(51) Int. Cl. B01D 46/00; F24F 13/28; F24F 3/16

(52) U.S. Cl. CPC B01D 46/0028; F24F 3/1603; F24F 13/28; B01D 46/0005; F24F 2001/0096

(57) ABSTRACT

A positive pressure airflow blower system configured to deliver microbe-free air to a target room. The positive airflow pressure blower system can comprise at least a) an air inlet sealingly connectable to an external air source that is external to the target room; b) a blower operably connected in sealed connection to the air inlet and configured to blow air solely from the inlet through an anti-microbe air filter into the target room; c) operably connected in sealed connection to the blower and the target room such that only air from the blower is transmitted through the anti-microbe air filter into the target room, wherein the anti-microbe air filter is sized and configured to remove at least bacteria, fungi and viruses from air passing through the anti-microbe air filter to provide microbe-free air; and, d) an anti-microbial seal disposed at a blower system-target room interface, wherein the seal is configured to seal the blower system-target room interface such that only microbe-free air is transmitted through the blower system and into the target room.

### CROSS-REFERENCE TO RELATED APPLICATIONS

The present application claims the benefit of co-pending U.S. Provisional Patent Application Ser. No. 61/895,627, filed Oct. 25, 2013, which application is incorporated herein by reference in its entirety.

### BACKGROUND

There are many circumstances where it is absolutely essential to assure a clean or sterile airborne environment. An obvious example is in hospitals, and especially in operating rooms of hospitals. In the operating room setting, it is the wound site of the patient where sterility is of most importance. Unfortunately, in current approaches, the most critical area of concern, the wound site, is not given direct-on-patient primary attention. Rather, current approaches have been just the opposite by giving attention to the condition of the operating room in general in creating a “clean” room with indirect overhead incoming air filtration creating a path for the ultraclean air to pass over objects before arriving on the wound site. This can result in the wound site actually being the area of least cleanliness because it is at the wound site that the most activity occurs during a surgical procedure that both sets contaminants airborne and blocks clean air access to the wound site.

Contaminated particles can be made up of particulates from any substance, such as dirt and dust, and can include bacterial and virus nebular matter transported either through the air from multiple sources or by touch on surfaces. Neither source of transport can be ignored. The same contaminates can pass from air to surface many times over the course of existence.

Thus, there has gone unmet a need for improved devices, methods, etc., for establishing a clean air environment at a targeted site, such as, for example, a surgically sterile wound site of a patient.

The present systems and methods, etc., provide these and/or other advantages.

### SUMMARY

The present devices, systems, etc., relate generally to a permanent or temporal positive pressure airflow blower system mounted on a ceiling or other structure located at a top or upper side of a target room such as an operating room comprising a surgical site, with the blower being internally mounted or separately connected within an enclosed air movement system that is attached to the intake opening of an air filtration assembly. The target room can be for example an operating room in a hospital, or an erected enclosure. The positive pressure airflow blower system can have varied airflow volume and/or velocity depending on the size of the filter in the blower, typically a HEPA or greater filter, and based on selector switches configured, for example, to vary the speed of the blower, for example to vary the focal length of the “Focused Clean Air zone” column. Typical sizes include a single blower approximately 2′×2′, or a two blower assembly approximately 2′×4′. Other sizes are possible, such as 2′×6′, 4′×4′, or other sizes including metric sizes. The positive pressure airflow blower numbers can be increased to assure the focal length of the clean air column produces clean air on the intended target.

The blower system optionally attaches to any type of permanent ceiling or temporary structure such as a dropped ceiling T-bar panel structure, standard smooth or textured finished ceilings, or near ceiling wall joists. The blower system provides ultra-high grade air at the bottom exhausting outlet side of the blower system. The blower system comprises an ultra-high efficiency type filter such as a HEPA, ULPA, or other ultra-high efficiency type filter, typically with a filter frame that is easily replaceable from the room side of the blower system, for example by using simple hand tools.

Thus, in one aspect the present devices, systems, methods, etc., provide a positive pressure airflow blower system configured to deliver microbe-free air onto a target within a room. The positive airflow pressure blower system can comprise at least a) an air inlet sealingly connectable to an external air source that is external to the target room; b) a blower operably connected in sealed connection to the air inlet and configured to blow air solely from the inlet through an anti-microbe air filter into the target room; c) operably connected in sealed connection to the blower and the target room such that only air from the blower is transmitted through the anti-microbe air filter into the target room, wherein the anti-microbe air filter is sized and configured to remove at least bacteria, fungi and viruses from air passing through the anti-microbe air filter to provide microbe-free air; and, d) an anti-microbial seal disposed at a blower system-target room interface, wherein the seal is configured to seal the blower system-target room interface such that only microbe-free air is transmitted through the blower system and into the target room.

In some embodiments, the anti-microbial seal comprises only materials configured to accept sterilizing agents without harming the materials, and can further comprise a removable filter cover configured to contact the anti-microbial seal with no gaps larger than a bacteria, fungi or virus. The blower system can be sized and configured to project a column of the microbe-free air that can be less than 1 foot in length to up to 6 feet, 8 feet, 9 feet in length, or other length as desired, and at least about 2 feet or 4 feet in diameter, or other diameter that can be almost as wide as the diameter of the selected filter outlet.

The blower system can further comprise a chamber housing containing a pressure equalization chamber located between the external -air inlet and the anti-microbial air filter and containing the blower, wherein the pressure equalization chamber can be sized and configured such that air transmitted from the blower to the anti-microbial air filter can be substantially uniformly pressurized at an interior surface of the anti-microbial air filter. The blower system can also comprise a system housing containing the air inlet, the blower and the anti-microbial air filter, and wherein a connection between the external-air inlet and the pressure equalization chamber can be centrally located in a top surface of the system housing. The blower can blow the air into the pressure equalization chamber in a 360 degree radius outward horizontally from the blower. The chamber housing and the system housing can be a single housing formed from the same or different materials.

Where the blower system comprises at least two blower fans, the blower systems can further comprise a distribution chamber sized and configured to accept external air from a single external-air inlet sealingly connectable to the external air source and to allow the air to move substantially evenly to both blower fans and can further comprise a dividing plate located between the at least two blower fans to eliminate heterodyning of airflow between the blower fans. The system can further comprise a anti-microbially-sealed electronics control compartment configured to hold electrical components within the blower system. At least the external-air inlet, the blower and the anti-microbial air filter can be disposed behind the blower system-target room interface such that the external-air inlet, the blower and the anti-microbial air filter do not project, or do not project more than ½″ or ¾″, the target room.

The blower system can further comprise a sealing gasket sized and configured to seal the system against a target room surface holding the blower system. The target room surface can be a ceiling surface. The blower system can further comprise a grill and a perforated grill retaining plate holding the grill to the blower system, and the blower system can further comprise an outside edge flange comprising a 90 degree outward angle and to hold the blower system to the target room surface holding the blower system.

The blower system can further comprise a pre-filter located upstream from the anti-microbial filter. The pressure equalization chamber can be at least 1.3 times or greater in diameter than a blower fan of the blower, and the blower system can further comprise a mounting plate located under the blower, the mounting plate sized and configured to separate and provide a discrete distance between a bottom of the blower and a top of the anti-microbial filter; the discrete distance can be large enough that the air pressure can equalize over the entire face of the filter. The blower system can further comprise an upper mounting plate located between the blower fan and the air inlet ring, which upper mounting plate can have struts to allow for mounting. The blower can also be a fully assembled with the air inlet ring as a single unit.

The air delivered to the anti-microbial filter has a cross-sectional variance in pressure of less than ±10%; the microbe-free air delivered from the anti-microbial filter has a cross-sectional variance in pressure of less than ±10%; and the microbe-free air delivered from the anti-microbial filter has a cross-sectional variance in velocity of less than ±10%.

The sealing gasket can be about 13/16″ in width and the sealing gasket comprises a sealing gasket surface and the sealing gasket surface comprises a cutout section positioned to allow for indicator system wiring to pass into the pressure equalization chamber. The sealing gasket can be made of neoprene, which can be a neoprene skinned foam.

An additional gasket seal can be provided around the perimeter of the surface between the grill and the parallel outer lip of the mounted housing with up to the 90 degree lip to completely fill that area so that no bacterial or virus growth can occur and cleaning the outer surface is easy from room side between cases. This gasket can be a rectangle in shape (or other shape that matches that shape of the air outlet into the target room) and can be made up of the same type of neoprene/neoprene skinned foam as the filter seal.

In other aspects, the current subject matter includes room comprising a positive pressure airflow blower system as discussed herein, which room can be in a constructed hospital room, i.e., a brick-and-mortar type of immoveable structure that is located in a single location, or in a deployable surgical room, i.e., a tent or other moveable room that can be erected in any desired location.

In other aspects, the current subject matter includes methods of making and/or using a positive pressure airflow blower system as discussed herein.

These and other aspects, features and embodiments are set forth within this application, including the following Detailed Description and attached drawings. Unless expressly stated otherwise, all embodiments, aspects, features, etc., can be mixed and matched, combined and permuted in any desired manner. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 depicts a cutaway perspective view of one embodiment of a blower system as discussed herein.

FIG. 2 depicts a perspective view of one embodiment of a blower system as discussed herein wherein certain elements of the blower system are separated from each other for clarity.

FIG. 3 depicts a cutaway side view of one embodiment of a flange attachment of a blower system as discussed herein to a structure holding the blower system.

FIG. 4 depicts a perspective view of one embodiment of a blower system as discussed herein wherein certain elements of the blower system are separated from each other for clarity and wherein the blower system comprises two blower fans.

FIG. 5 depicts a perspective view of one embodiment of a blower system as discussed herein wherein the system is located in a ceiling of a hospital and is connected to the HVAC system of the hospital as the external air source.

FIG. 6 depicts a perspective view of one embodiment of a blower system as discussed herein wherein the system is located in a wall of a deployable surgical room and is connected to outside air as the external air source.

### DETAILED DESCRIPTION

Briefly generally discussing the systems, methods, etc., herein, the blower systems are fitted to draw air from a sealed facility rigid or flexible duct, an open air plenum, or any other designated source. The blower systems are capable of producing a “Focused Clean Air Zone”TM i.e., a projected column of ultra clean (microbe-free) air that envelopes a target site; one example of such a Focused Clean Air Zone™ (FCAZ™) can be found in co-owned U.S. patent application Ser. No. 13/195,384, entitled, “ARRANGEMENT AND METHOD FOR FORMING A FOCUSED CLEAN AIR ZONE COLUMN”, incorporated herein by reference in its entirety. The ultra-clean, highly filtered airstream envelope can protrude downward, sideways, or angled into the room, or an undirected overall volume and velocity of ultra-clean certified HEPA or better filtered air can be transmitted into a room or enclosure such that all air directed onto the target and the room is microbe-free. Placement of the blower filter unit(s) can be placed in certain places to assure that the desired room airflow dynamics is achieved. The airflow volume from the blower system can be adjusted as desired, for example by use of a wall or externally mounted programmed speed controller or pre-programmed hand signals. All components that might potentially fail can be replaceable from the room side when the filter is removed.

Optionally, such as where more than one blower fan is provided in the blower system, such as in some 2′×4′ positive pressure airflow blower systems, the systems can comprise a distribution chamber securely mounted on top of the blower system or elsewhere as desired that allows a single inlet opening and unencumbered space to allow the air to move to both blowers that are placed at each half of the standard device. Another option is the placement of sound producing speakers placed in the high-pressure plenum, typically pointed downward to project the sound waves through the high-efficiency filter without sound distortion. This option can be used to offset the noise produced by the blower(s) and/or to provide voice or music connected electrically to an apparatus out of the sterile field that can convert or provide these sounds. Another option is for this noise producing system to be mounted outside the filter housing adjacent to the filter device if desired.

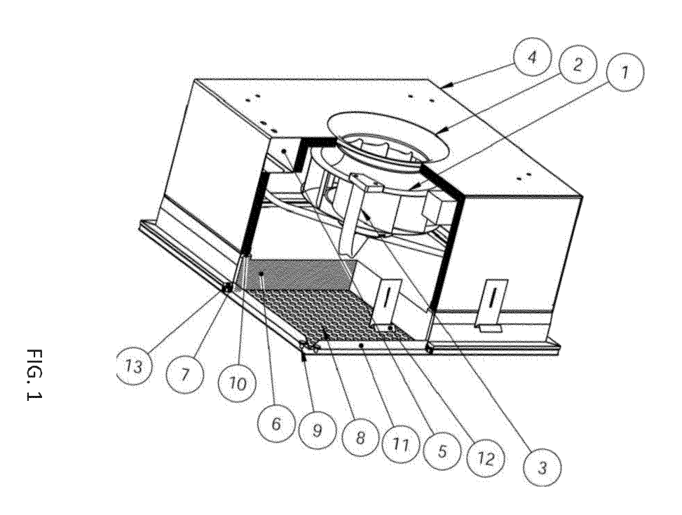

Turning to a discussion of some specific embodiments, in FIG. 1, the positive pressure airflow blower systems comprise several major structure components described as the air flows through the device. These include an external-air inlet opening with a secure sealed surface for sealed connection to an external air source such as an in-facility HVAC system or to field operation ducting, and a blower fan such as motorized impeller blower 1. The blower

systems can comprise an inlet ring 2, mounted separately if desired, and a blower mounting bracket 3, a pressure equalization chamber 4, an electronics control compartment 5, an anti-microbial filter such as a HEPA or better filter 6, wherein the filter is configured to remove biological contaminants including bacteria, fungi and viruses from the air. All of these components can be maintained above the ceiling parting line, i.e., line where the blower system meets the ceiling of the room, such that the anti-microbial filter is maintained above the lower surface of the ceiling when the device is used in a ceiling.

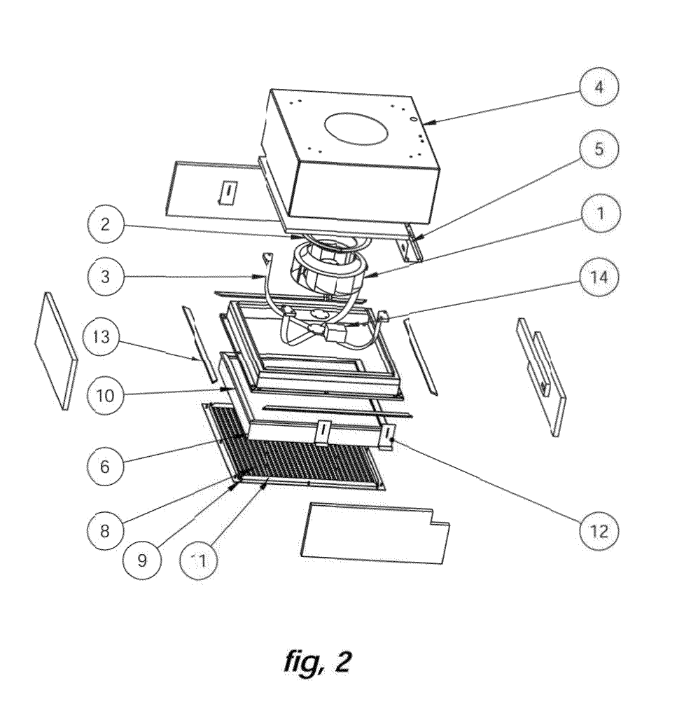

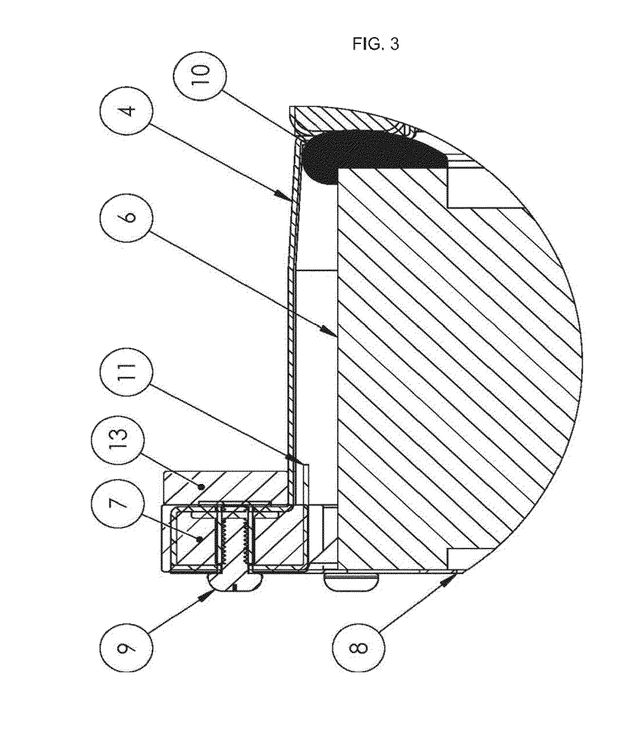

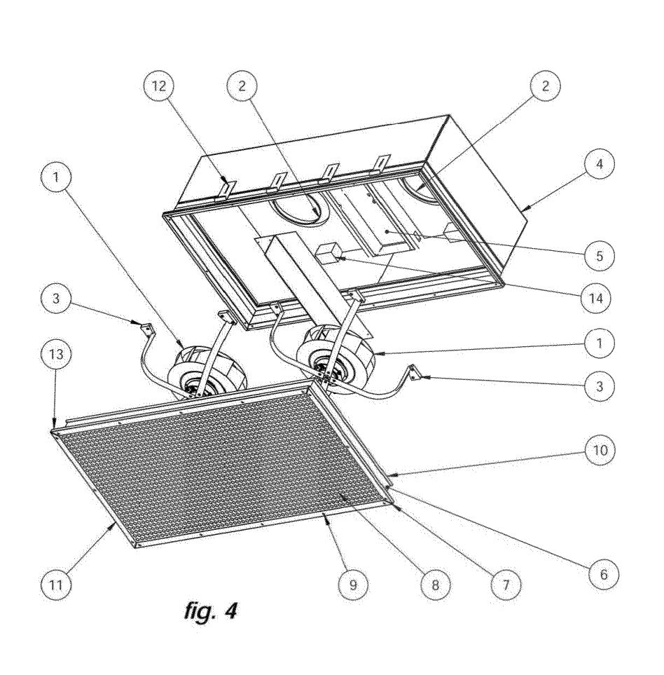

As also shown in FIGS. 2-4, below the ceiling parting line the assembly of the positive pressure airflow blower system protrudes very little into to the room, typically less than 1 inch into the room. The elements below the ceiling parting line in the embodiment shown, and as shown particularly in FIG. 3, comprise the bottom edge of the HEPA filter 6, This same metal flange on the opposite side provides attachment points for the air grill retaining nut inserts and again is bent 90 degree outward to form the outside perimeter finish wall of the outside edge flange 14. The filter grill 8 is a flat, perforated plate with 70 percent or more open area to match the size of the filter opening and with the outside edges of the plate formed of solid material. Around the edges of the perforated retaining panel a further L-shaped piece of metal 11 is attached with the short lip pointed upward to centralize the placement of the filter for ease of installation and additional strength.

Periodic replacement of the filter can be accomplished by mounting fasteners 9, which fasteners can also provide pressure to compress both the filter frame gasket and outer space gasket and secure a seal such that no microbes can traverse the seal between the blower system and the structure holding the system, such as a ceiling or wall of an operating room or some other target room. Between grill retaining plate 8 and the outside housing 14 is the sealing gasket 7, which in this case acts to inhibit bacterial growth as well as growth of other contaminants such as fungi. The sealing gasket 7 can comprise a rectangular foam core with a skinned outer surface, and can be permanently or removably installed to the receiving housing surface. The sealing gasket can be considered an anti-microbial seal and can be made of any appropriate material that both seals the gasket to the ceiling and inhibits or prevents microbial growth. Thus, one purpose of the gasket 7 is to eliminate any gap between the grill edge and the outer housing edge to eliminate potential bacterial growth cavities and to provide a surface upon which a sterilizing agent can be wiped during cleaning by facility personnel.

In the embodiment shown, the air is pushed through a HEPA or other high-grade filter 6 by an upstream, electrically powered motorized impeller 1 or other fan or other type of blower(s), enclosed within the device. The impeller 1 and inlet ring 2 are each mounted separately and can be positioned precisely with each other to reduce noise and maintain operational performance efficiency, or they can be a preassembled combined single unit.

Again referring to this embodiment, the inlet ring 2 can be mounted first to the outer wall surface permanently. The blower is mounted to a spider like aerodynamically shaped blower mounting bracket 3 that both provides all axis rigidity and allows for minor adjustment to position the blower in relation to the inlet ring. The arms of the mounting bracket have an aerodynamic shape on the underside to allow the air to freely pass over without creating excessive turbulence while minimizing airflow blockage. On the opposite side of the bracket is a “V” shape that provides both bracket strength and a cavity to retain the blower power wires to safely extend beyond the outer exposed edge of the blower. At the point where the wires exit the bracket cavity, a small indentation is made around the outer bracket surface to provide a secure place for a surrounding tightened strap. At that point the blower wires can be positioned over the side and with a designated plug be plugged into the electronics control compartment 5 for easy replacement if desired. The arms of the spider blower mounting bracket 3 have a flat connection between the outer ends of the legs and mount directly into a template placed receiving mounting bracket permanently attached to the outer housing. This blower mounting bracket 3 because of its shape allow it to be manufactured either of metal or composite material. Utilizing this mounting bracket design allows easy field replacement as a single assembly, from room side, with the filter 6 and grill plate 8 removed.

An integrated motorized impeller 1 with a flanged inlet ring 2, or other type of housed blower, is mounted inside the incoming upper plenum chamber, here a pressure equalization chamber 4, of the assembly, is positioned to pull the air in through the inlet of the blower powered air register and positively pressurize the upper plenum equalization chamber. This pressurized upper plenum chamber and the filter portion of the housing remain hidden above the finished ceiling or dropped support T-bar grid and panel ceiling. In other words, these parts of the blower system are maintained outside the sterile room. This reduces the amount of extra surface area, and the amount of extra nooks and crannies inside the sterile area in which microbes can grow, thereby also reducing the amount of area and nooks and crannies that must be sterilized and/or kept clean.

Inside of the upper housing equalization plenum area, for example along one side near the ceiling, is a cavity to house or serve as the sealed electronics control compartment 5. This houses the electronics that control the blower operation and speed along with any other sensors that might be added. This cavity has a removable cover that is secured with self-tapping screws and is accessible from the room side when the HEPA filter 6 and retaining grill plate 8 is removed from the device. The shape of the electrical compartment can be along the entire wall on one side adjoining the top surface of the upper plenum housing. The top level of the housing can be at the level of the blower impeller and near the intake-edge, which can limit any reduction of blower performance.

The wall of the electrical housing 5 is provided with openings. Component plugs allow easy replacement and assembly of any electrical components in the equalization chamber itself. Also in the top surface of the electronics control compartment 5 are two or more plug openings external low-voltage electrical wiring. Additionally, electrical power can be hard wired for permanent installation or supplied with an attached cord for field usage.

The positive pressure airflow blower system can be equipped with opposing wall mount clips 12 that are intended to allow clipping over the top edge of T-bar ceiling grid system. This arrangement provides for attachment without requiring holes drilled into the grid system thereby leaving no trace of the installation if the blower systems were to be later removed. These brackets can be of bent sheet metal attached to the outside vertical wall of the filtration device and can be adjusted vertically to fit the height of the T-bar vertical leg. Access to the attachment brackets can be from inside the device housing and only requires tightening of the fasteners once everything is adjusted as desired. Additional mounting brackets are connected at some point on the upper outer surface of the outside wall to hang it from the facility ceiling as required to meet building codes.

In the case where a larger filtration device is built such as a 2′×4′ device, two blowers of like size and two inlet rings would be used incorporating the mounting system described above, or a larger impeller and larger components can be used. An additional air chamber can be added on the inlet topside to provide an upper inlet pressure equalization chamber where a one or more inlets can be attached to the air supply duct, and thus the air would have the volume to flow

to each blower. Also when two or more blowers are incorporated, a dividing plate can be installed that directly breaks up line-of-sight view between the blowers to eliminate heterodyning of airflow between the blowers that reduces efficiency and increases the blower noise. By utilizing a larger capacity blower and keeping the blower speed down, the noise level is reduced for usage in quiet areas. A 2′×2′ device is capable of delivering up to 500 cubic feet per minute volume of air at 150′ per minute filter face air velocity. The 2′×4′ size device can produce up to about twice the airflow volume at the same air velocity.

The blower systems herein can incorporate a two-sided clamping option to allow clean and non-marking attachment to the T-Bar upon removal of the unit. The ceiling blower/filtered room air inlet register can also be attached directly to the T-bar by screwing through the extend lip around the outer edge through the precut opening in the sealing gasket 7 of the grill 8. This same attachment option can be utilized for other types of ceiling support joist materials. Additionally the device can be secured with screws placed directly through the side walls of the pressure equalization chamber 4, from the inside, into ceiling joists spaced at least 24 inches, on center and/or supported through the ceiling of the housing, under a “Unistrut” channel or welded support structure attached with screws through the top outer corners of the recessed housing, or otherwise as desired.

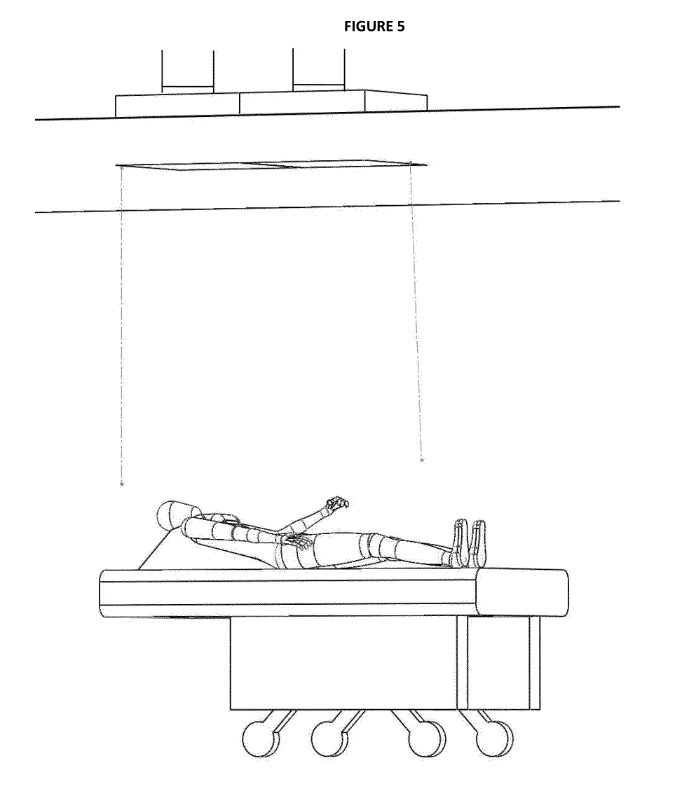

FIG. 5 shows the blower systems herein can be located in a ceiling of a immobile hospital and connected to the HVAC system of that hospital as the external air source.

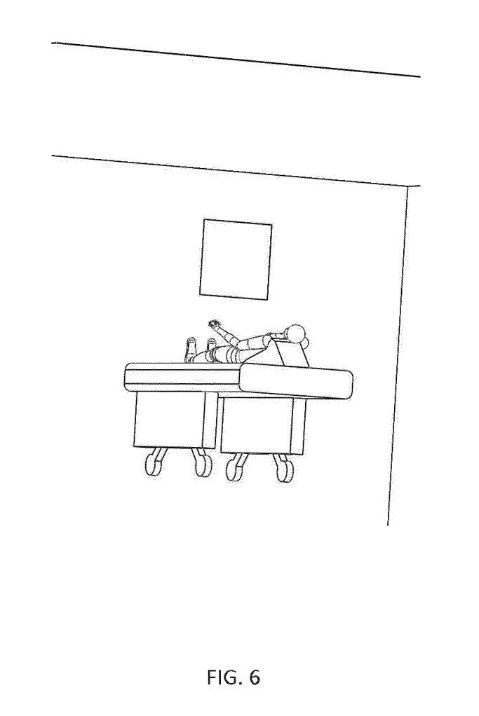

FIG. 6 shows the blower systems herein located in a wall of a deployable surgical room and connected to outside air as the external air source. Other connections to various air sources are also possible as desired.

The positive pressure airflow blower systems can be optionally configured to provide for a pre-filter located above the ultra, high-grade filter. This option could be used to pre-clean incoming air before the ultra, high-grade filter encounters the air, possibly increasing the life of the ultra, high-grade filter or provide a placement for a pre-filter that would provide filtration for molecule filtration. To access the pre-filter from the room side, the HEPA filter can be configured to be removed as a unit as the pre-filter is positioned directly above the HEPA filter with a deeper filter socket to accept the pre and final filter package.

The positive pressure airflow blower systems herein utilizes a sealed plenum chamber housing, i.e., a pressure equalization chamber 4 in FIGS. 1-4, which can be hidden above the T-bar grid or ceiling line. The pressure equalization chamber 4 contains an inlet duct port positioned over the blower inlet, typically in a central location on the top surface of the chamber. Below the inlet duct port is the blower correspondingly positioned with the inlet of the blower facing upward. The blower, which can be impeller 1, pressurizes the plenum chamber area before the air is discharged to the room. In one embodiment, the air from the blower is blown within the chamber in a 360 degree radius outward horizontally to fill the upper air plenum chamber. The air then passes through the final filter housing portion of the blower system, i.e., the portion that is exposed and positioned below the T-bar grid.

The entire air volume residing within the blower systems herein, once it enters the upper air plenum chamber, is securely sealed until it exits through the blower system thus eliminating any bypass or leakage of unfiltered air entering the room. The shape of the blower system's housing area allows the hidden top blower portion of the assembly to fit above the normal T-bar grid device and be directly positioned the opening of a normal ceiling air register.

The pressure equalization chamber can be sized such that it is at least 1.3 times the diameter of the blower fan.

The mounting plate under the blower can serve to separate and provide a discrete distance between the bottom of the blower and the top of the filter media, wherein the distance is large enough that the air pressure can equalize over the entire face of the filter. This can allow the entire filter to exhaust the air at a cross-sectional variance in pressure of less than ±10%. When the airflow pressure is evenly distributed across substantially the entire face of the outlet filter, the entire air filter surface area can be used, thereby assuring good laminar airflow as the ultra-clean air exits the filter without any substantial disproportional airflow spikes across the face of the filter. Typically, the uniform air velocity across the filter face is within ±10 percent per cleanroom ISO design specification.

The filtered airflow volume discharged by the blower systems herein, when connected directly to a facility HVAC system, is typically designed to not over-power and pull too great a percentage of the total facility HVAC capacity into just the controlled room, thereby avoiding causing the remaining portion of the facility to operate below recommended airflow standards.

The blower systems can incorporate an air intake attachment flange that allows attachment of the systems to be appropriately sized to provide a direct sealed connection to the intake top portion of the blower systems. Also the register assembly incorporates an electrical connection box, on the upper sidewall, to allow direct connection to the electrical supply and EC motor control indication components. Because the blower power demand is low, this electrical connection can be attached to normal existing electrical circuits.

The secondary or lower stage of the filter holding portion of the blower systems is typically directly positioned below the blower and pressure equalization chamber portion and is positioned above the ceiling surface. This area is sized to allow the air to curve around mounting brackets, etc., and yet still have an equalized airflow velocity across the filter opening. This portion of the assembly can be separated by an inward protruding lip that is the primary receiving surface of the filter gasket and is not exposed to the room side.

The portion of the housing assembly that contacts the ceiling of the target room can incorporate a lower horizontal flat surface positioned directly against the lower side of the ceiling surface with a lip that protrudes downward about 0.50″ to 0.75″ with molded sponge gasket with a skin around the entire outer surface on the inside of the 90° projecting side lip to reduce the opportunity to have bacteria growth or other microbe growth through a crevice or cavity between the side lip and the grill covering the perforated plate. This sealing gasket can be about 13/16″ wide and applies backpressure to the tightening of the perforated grill cover to housing frame. The sealing gasket can be provided with strategically placed holes to allow threaded lugs to protrude through the gasket and extra holes to allow optional screw mounting as a way to install the filtration device into a cavity or hole in the ceiling. Additionally, the sealing gasket can have a cutout that is shaped to conform to the shape of a lighted “remaining filter-life” status indicator exposed on the face of the device so that persons in the target room can determine the remaining life of the filter. In one embodiment, this gasket is tightly wrapped around the indication module with the connecting wires routed through the filter gasket receptacle underneath the gasket.

In some embodiments, the filter gasket receptacle shape and size can be an aligned, wall-surface outer lip to within ⅜ inch distance and then has a 4° to 5° inward-angled side vertical lip that provides the side and corner surfaces for the filter seal receptacle. The flat bottom surface of the filter gasket receptacle is at 90° to the outside lip towards the inside and extends to the inner edge of the filter frame to allow full surface contact of the seal primary surface and to tighten the filter grill. The primary gasket surface can be provided with a cutout section corresponding to the cut out in the gasket that is positioned to allow for indicator system wiring to pass into the pressure equalization chamber without undue bending. A bolt-attached replacement shape plate can be installed to provide a primary surface with only a small amount of cleanroom approved caulking on the pressure equalization chamber side to seal the edge after the wiring is routed. This gasket socket arrangement is specifically designed to assure a complete air seal.

One example of a suitable material is a neoprene type-sealing gasket, which has a closed cell core and a smooth sealed surface on all outside surfaces. The sealing gasket can be permanently mounted on the upper portion and outside corner and short top wall of the filter frame for the blower system.

The gasket shape and corner interlocking design discussed herein provides for improved ease of manufacturing capability on the outside edge allowing easy installation and cutting with improved corner interlocking capability with no straight-line airflow bypass capability. The vertical lip additionally provides an attachment point for the filter encapsulating bezel frame. The finished grill panel is designed to provide equal pressure along all the bottom edge of the filter frame with bent metal centering and structural strengthening of the flat grill outlet plate when fully attached with the screws around the outer edge of the grill panel, compressing the filter gasket equally around all top surfaces of the filter, gasket corner and side surfaces into the bottom portion of receiving filter socket while compressing the outer bacterial gasket at the same time.

The high-grade filter gasket is manufactured to be soft and easily compressible, with the interior being closed cell plastic or other suitable polymer or material, and the exterior being an outer smooth sealing skin. This allows for the non-distortion of the top filter head assembly at a much lower pressure, and allows for a desired amount of compression of the filter gasket when fitted around the air filter, even if multiple clamping subassemblies have been utilized. This provides a completely sealed clean air supply device, which, when handled properly and used properly, results in the elimination of any requirement to go through a potential filter gasket leakage test each time the filter is changed and the device is re-energized.

Additional ceiling mounted blower powered air filter room inlet register assemblies can be strategically placed in the ceiling to accommodate larger room volume, to increase higher overall room airflow volumes, to increase room positive air pressure in a desired area, or increase room air exchanges and flow patterns with secondary benefit of more evenly distributing the clean air in the entire room and thereby eliminating most undesirable stagnant air pockets. Another option is to cluster a number of these air filtration devices together creating a much larger cross sectional face area of wide breath size for the Focused Clean Air Zone (FCAZ). The overall outer size of these blower systems herein, both below and above the ceiling parting line, can be configured to allow clustered devices to fit in the standard T-Bar ceiling grid system yet also allow service and secure installation attachment without modifying the T-bar grid system itself.

### Further Discussion of Certain Electrical Components

An on-board central microprocessor “engine” can control all autonomous functions of the positive pressure airflow blower systems herein. In addition, it can communicate and be controlled by others, for example via an optional wall mount controller or USB computer interface. An exemplary basic operational block diagram is below:

All “engines” have the same electronic architecture, but can be firmware configured to allow customizable features and functions. The central processor provides system control, output data communications, input configuration communications, and output indication/alarm functions.

### Exemplary Functional Blocks of the Electrical System are as Follows:

Power Supply—The power supply module allows for a wide range of input line voltages and frequencies. The power supply module output can provide a constant DC voltage for the central processor, communications, alarms and input devices. The power supply module can provide power application sequencing for safe power up and unexpected or planned power down events.
Central Processor—The embedded firmware can instruct the operating system to control the positive pressure airflow blower system. An operational program loop can reside within the central processor and can command hardware operation, collect analog and digital input data, and make decisions, using typical mathematical applications based on the input data and stored constants. Hardware interfaces for the central processor are divided as follows:

### Sensing/Control:

1. Fan speed control
2. Measurement of fan speed
3. Monitoring of electrical voltages and currents throughout the positive pressure airflow blower system
4. Fan speed set point
5. Pressure sensor inputs
6. Filter installation/removal and presence/absence sensors
7. Balancing/synchronizing control for multiple units in parallel

### Annunciation:

1. Control of visual indicators to report filter status (e.g., 5 green LED's to count down remaining months of life of the filter; 6th month is yellow LED; thereafter is red LED)

### System Support:

1. Early loss-of-power indicator with time stamp
2. Real time clock (RTC)/counter with battery (or other energy storage device like a capacitor) backup
3. Visual “good operation” indicator for the filter, possibly including an indicator of anticipated remaining life for the filter
4. Visual indicators of proper voltage levels on each bus
5. Non-volatile memory device that stores system information, serial numbers, calibration constants and program constants
6. Error codes are stored and retrieved for use in troubleshooting the system

### Communications:

1. ASCII: general purpose serial connector communications to external devices such as computers and networks or node wireless interfaces supporting standard communications such as:
   a. IEEE-802-11 Ethernet
   b. IEEE-802-15 Zigbee wireless mesh or star network
   c. EIA-232 interface
   d. M/STP (Master/Slave Token Passing) on a multi-drop network
2. USB-2.0: communications interface for manufacturer or customer service access to the control system

Sensors: Various electronic devices are interconnected to the central processor via of several standard communications methods, including parallel or serial I/O, both wired and wireless, using a plurality of protocols and methods. Exemplary peripheral devices include without limitation:
Low power “green” energy-saving mode, which is triggered when the room or blower is not being used. Non-use operation can be programmed to reduce power consumption during off hours via a repeatable daily clock cycle. Alternately, sensing for non-use can be accomplished to sense occupancy via motion, light or heat sensors or other suitable technology.
A built-in tachometer speed sensor within each blower motor measures speed of rotation of the blower. In the single blower version, this feedback is used to control the speed of the blower. In the two or more blower configuration, such as some 2′×4′ configurations, this motor feedback is used to synchronize the two blowers so that a seeking control loop doesn't cause heterodyning and excessive noise.

The blower systems can further comprise a smoke sensor triggering an emergency shutdown. This feature can be implemented internally or externally from a facility-wide signal of emergency fire sensing equipment.

The HEPA filter typically requires changing every 5 months. Indicators show the amount of time elapsed since the filter was newly installed. A sensor is utilized to sense the changing of the filter. This sensor can be a mechanical switch, an electrical contact, a proximity sensor, a magnetic sensor, or any other sensor that detects continuous presence of the filter or the moment of removal for change out.

The HEPA filter captures particles in its many membranes. When the filter no longer allows enough flow due to “clogging”, the upstream pressure increases due to back pressure. Filter usability can be sensed by the differential pressure across the filter from the high pressure (upstream) side to the low pressure (downstream) side. Alternately, only the upstream back-pressure can be measured and compared to the room (atmospheric) pressure.

The air can be sensed and measured in-process for quality of the air. Air particles can be measured so that the air can be assured of cleanliness. Humidity can be sensed and controlled as well as gasses within the air, either beneficial like oxygen, or harmful like noxious gases, can be measured with sensors in the airstream. Gasses can also be added and the amount monitored and regulated. Gasses can also be eliminated by scrubbing and monitoring the effectiveness.

The filter flow chart below shows exemplary airflow information of the Focused Clean Air Zone, including dropping air velocity as the column of air moves from the filter, the cleanliness levels, the distance in feet, and column shape as tested.

### Options Discussion

A handheld wired or wireless controller can be used to control basic functions of setup for service personnel. The handheld device can be a specialized controller or a laptop PC with custom software used to adjust fan speed, read S/N and error codes or reset filter life indications.

### Some of Further Aspects of the Embodiments Described Herein are Set Forth Below.

1. Bezel Gasket

The gasket that seals the bezel grill to the housing fixed in the ceiling completely seals all exposed cracks around the grill and the exposed housing joint hanging down into the room. This allows the ability to easily wipe down the smooth face surface and small side edges completely with cleaning chemicals and affords no exposed cracks for bacteria to hide and grow. The joint allows visual inspection to assure personnel the gap-filling gasket is present beneath the jointing point.
2. Outer Lip

The exposed housing can penetrate into the target room no more than about ½″ to 1″ and can extend outwardly away from the room more than one-half of the T-bar flat surface thereby eliminating space between side-by-side mounting of devices to provide a larger overall facial area for filtration. Additionally this lip provides a means to seal the device to the ceiling surface. Also, a sealing gasket can be used between adjacent units if more than one is installed to minimize gaps and provide a clean smooth surface. This short penetration is meant to allow easier cleaning between usages. This arrangement of filter and lip when combined provide a minimized protruding exposure beneath ceiling surfaces for reduced irregularities and cleaner look to the area.
3. Device Serviceability

The device is designed to allow room-side service of all components once the device is installed. This includes electronics, future placement of wireless antenna, blower replacement and filter replacement. The electronics are shielded for EMI all within the metal compartment with a removable cover.
4. Blower Mounting Support

The support structure that holds the blower in the housing has a unique aerodynamic “V” shaped cross-section that minimizes turbulence of the blower air which reduces the audible noise of the blower. In addition, the shape strengthens the structure to hold the blower concentric for greater efficiency. Additionally, the “V” shape provides a protected “wire-way” to route the blower wire to the electrical control enclosure. The “V” shape along the top portion provides an aerodynamic foil for smooth airflow over that portion of the mounting bracket. As the mounting bracket makes the transition to the vertical direction to position the blower around the inlet ring, the “V” is smoothly curved to provide an aerodynamic profile for the air leaving the blower blades to flow by the supporting arms. The four support feet only orient one way upon assembly to avoid miss-assembly upon field replacement. Additionally one support arm is designated to provide a safe trough for the blower power wires to nest. The wires are held in place with ties strategically placed along that arm. The mounting holes register over the fixed nuts for ease of alignment while fastening the screws that are captive on the mating part.
5. T-bar Clamps

The T-bar clamping brackets are placed and attached to the outside of the side wall of the non-exposed portion of the device housing. Each clamp is designed to provide a means to lock over the top edge of the T-bar. The mounting T-bar clamps can be offset so that side-by-side mounting can be used.
6. Sound Speakers

The speakers are mounted above the HEPA filter for cleanliness of the room, yet deliver “clean sound” to the room through the filter on the air stream of the exiting air. The sound can be music for the enjoyment of patient, nurse or doctor. The sound can be a curtain of “white noise” to drown out extraneous sound. The sound can also be “inverted wave” to cancel out extraneous room sound and the noise from the blower. When desired, the speakers can be mounted outside the blower/filter housing but connected to the device for electrical sourcing.
7. Air Delivery

The system is designed to deliver a variable volume and velocity of air to the room up to 550 cubic feet/min (CFM) at a velocity of 175 feet/min (FPM) which constrains the system to deliver a non-mixing laminar column of increased pressure HEPA filtered air outward from the downwind face and through the 78% open area safety grill. The filter sealing gasket system allows easy field replacement of the certified HEPA filter. The HEPA or better filter is certified in that each filter is challenged tested with the installed patented gasket arrangement.
8. Filter

The filter sealing gasket system allows easy field replacement of the certified HEPA filter. The filter's expected life before replacement is easily ascertained with the built in controller's indicator to guarantee clean air is delivered.
9. Recording History

The recorded history is stored in the electronic memory within the electrical enclosure. This history of operation is downloadable through an interface connector with software to an external storage system. Additional sensors can be added to provide additional information of operation within the device.
10. Wireless Communications

The device can have an antenna placed internal or external to provide for safe transmission of selected information to be displayed as desired, for example at a facility service desk and operational information at a central management desk. This wireless information will interface with the facility wireless system.
11. Interconnecting Ports For Hard Wiring Connections As Desired

The device can have a low voltage connection port to provide data and management to a wall mounted controller. There is also a port that provides a means to daisy-chain to other mounted devices so that the entire combination of devices can be interconnected and operate as an entire system.

The present application is further directed to methods of making the various elements of the systems and apparatus herein, including making the systems and apparatus themselves from such elements, as well as to methods of using the same.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

1. A positive pressure airflow blower system configured to deliver microbe-free air onto a target within a room, wherein the positive airflow pressure blower system comprises:
a) an external-air inlet sealingly connectable to an external air source that is external to the target room;
b) a blower operably connected in sealed connection to the external-air inlet and configured to blow air solely from the inlet through an anti-microbe air filter into the target room;
c) the anti-microbial air filter operably connected in sealed connection to the blower and the target room such that only air from the blower is transmitted through the anti-microbe air filter into the target room, wherein the anti-microbe air filter is sized and configured to remove at least bacteria, fungi and viruses from air passing through the anti-microbe air filter to provide microbe-free air; and,
d) an anti-microbial seal disposed at a blower system-target room interface, wherein the seal is configured to seal the blower system-target room interface such that only microbe-free air is transmitted through the blower system and into the target room.

2. The blower system of claim 1 wherein the anti-microbial seal comprises only materials configured to accept sterilizing agents without harming the materials.

3. The blower system of claim 1 wherein the blower system further comprises a removable filter cover configured to contact the anti-microbial seal with no gaps larger than a bacterium, fungi or virus.

4. The blower system of claim 1 wherein the blower system is sized and configured to project a column of the microbe-free air that is at least about 6 feet in length and at least about 2 feet in diameter.

5. The blower system of claim 1 wherein the blower system is sized and configured to project a column of the microbe-free air that is at least about 8 feet in length and at least about 4 feet in diameter.

6. The blower system of claim 1 wherein the blower system further comprises a chamber housing containing a pressure equalization chamber, the chamber housing located between the external-air inlet and the anti-microbial air filter and containing the blower, wherein the pressure equalization chamber is sized and configured such that air transmitted from the blower to the anti-microbial air filter is substantially uniformly pressurized at an interior surface of the anti-microbial air filter.

7. The blower system of claim 6 wherein the blower system comprises a system housing containing the air inlet, the blower and the anti-microbial air filter, and wherein a connection between the external-air inlet and the pressure equalization chamber is centrally located in a top surface of the blower system housing.

8. The blower system of claim 6 wherein the blower blows the air into the pressure equalization chamber in a 360 degree radius outward horizontally from the blower.

9. The blower system of claim 6 wherein the chamber housing and the blower system housing are a single housing formed from the same material.

10. The blower system of claim 1 wherein the blower system comprises at least two blower fans and wherein the blower systems further comprise a distribution chamber sized and configured to accept external air from a single external-air inlet sealingly connectable to the external air source and to allow the air to move substantially evenly to both blower fans.

11. The blower system of claim 10 wherein the blower system further comprises a dividing plate located between the at least two blower fans to eliminate heterodyning of airflow between the blower fans,

12. The blower system of claim 1 wherein the blower system further comprises an electronics control compartment configured to hold electrical components within the blower system.

13. The blower system of claim 12 wherein at least the external-air inlet, the blower and the anti-microbial air filter are disposed behind the blower system-target room interface such that the external-air inlet, the blower and the anti-microbial air filter do not project into the target room.

14. The blower system of claim 1 wherein the blower system further comprises a sealing gasket sized and configured to seal the blower system against a target room surface holding the blower system.

15. The blower system of claim 14 wherein the target room surface is a target room ceiling surface.

16. The blower system of claim 1 wherein the blower system further comprises a grill and a perforated grill retaining plate holding the grill to the blower system.

17. The blower system of claim 14 wherein the blower system further comprises an outside edge flange comprising a 90 degree outward angle sized and configured to hold the blower system to the target room surface holding the blower system.

18. The blower system of claim 1 wherein the blower system further comprises a pre-filter located upstream from the anti-microbial filter.

19. The blower system of claim 1 wherein the pressure equalization chamber is at least 1.3 times or greater in diameter than a blower fan of the blower.

20. The blower system of claim 1 wherein the blower system further comprises a mounting plate located under the blower, the mounting plate sized and configured to separate and provide a discrete distance between a bottom of the blower and a top of the anti-microbial filter.

21. The blower system of claim 20 wherein the discrete distance is large enough that the air pressure can equalize over the entire face of the filter.

22. The blower system claim 1 wherein the air delivered to the anti-microbial filter has a cross-sectional variance in pressure of less than ±10%.

23. The blower system of claim 1 wherein the microbe-free air delivered from the anti-microbial filter has a cross-sectional variance in pressure of less than ±10%.

24. The blower system of claim 1 wherein the microbe-free air delivered from the anti-microbial filter has a cross-sectional variance in velocity of less than ±10%.

25. The blower system of claim 14 wherein the sealing gasket is about 13/16″ in width.

26. The blower system of claim 25 wherein the sealing gasket comprises a sealing gasket surface and the sealing gasket surface comprises a cutout section positioned to allow for indicator system wiring to pass into the pressure equalization chamber.

27. The blower system of claim 14 wherein the sealing gasket is made of neoprene.

28. The blower system of claim 4 wherein the blower system further comprises at least one light attached to the blower system and wherein the at least one light is focused on a target site located within the column of the microbe-free air.

29-35. (canceled)
